(19) United States
(12) Patent Application Publication
(10) Pub. No.: US 2026/0292908 A1
(43) Pub. Date: Sep. 24, 2026

(54) FAST CONFLICT RESOLUTION IN WIRELESS COMMUNICATION SYSTEM

(71) Applicant: LG ELECTRONICS INC., Seoul (KR)

(72) Inventors: Hongsuk KIM, Seoul (KR); Sunghoon JUNG, Seoul (KR)

(73) Assignee: LG ELECTRONICS INC., Seoul (KR)

(21) Appl. No.: 18/998,080

(22) PCT Filed: Jul. 24, 2023
(86) PCT No.: PCT/KR2023/010644

§ 371 Date: Jan. 23, 2025

Related U.S. Application Data
(60) Provisional application No. 63/391,801, filed on Jul. 25, 2022.

(51) Int. Cl. H04W 76/15; H04W 8/24

(52) U.S. Cl. CPC H04W 76/15; H04W 8/24

(57) ABSTRACT

The present disclosure relates to fast conflict resolution in wireless communications. According to an embodiment of the present disclosure, a multiple universal subscriber identity module (MUSIM) user equipment (UE) registered in a first network and a second network may operate in dual connectivity (DC) in the first network, and may transmit, to the first network, conflict information informing a capability conflict between a first resource used in the first network and a second resource for use in the second network via a secondary cell group (SCG) based on the first resource being related to a primary cell (PCell) in a master cell group (MCG).

### CROSS-REFERENCE TO RELATED APPLICATION(S)

This application is the National Stage filing under 35 U.S.C. 371 of International Application No. PCT/KR2023/010644, filed on Jul. 24, 2023, which claims the benefit of U.S. Provisional Application No. 63/391,801, filed on Jul. 25, 2022, the contents of which are all incorporated by reference herein in their entirety.

### TECHNICAL FIELD

The present disclosure relates to fast conflict resolution in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may perform operations using radio resources e.g., first radio resource and second radio resource. However, there may be a case UE's capability does not support simultaneously performing operations on a first radio resource and operations on a second radio resource. This may be referred to as there is a capability conflict between the first radio resource and the second radio resource, and/or the first radio resource conflicts the second radio resource. Conflict may occur various situations, such as in multiple networks (e.g., first network and second network) related to multiple universal subscriber identity module (MUSIM) operations. During the MUSIM operations, PCell in the first network may conflict a frequency of camping cell/serving cell on the second network. In this case, conflict resolution is required.

### SUMMARY

An aspect of the present disclosure is to provide method and apparatus for fast conflict resolution in a wireless communication system.

Another aspect of the present disclosure is to provide method and apparatus for conflict resolution in MUSIM operations in a wireless communication system.

Another aspect of the present disclosure is to provide method and apparatus for resolution of conflict on PCell in MUSIM operations in a wireless communication system.

According to an embodiment of the present disclosure, a method performed by a user equipment (UE) in a wireless communication system comprises: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict, wherein the conflict information is transmitted via the SCG based on the first resource being related to a primary cell (PCell) in the MCG.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict, wherein the conflict information is transmitted via the SCG based on the first resource being related to a primary cell (PCell) in the MCG.

According to an embodiment of the present disclosure, a master node (MN) related to a master cell group (MCG) in a first network configured to operate in a wireless communication system comprises: at least one transceiver; at least one processor; and at least one memory operatively coupled to the at least one processor and storing instructions that, based on being executed by the at least one processor, perform operations comprising: establishing a connection with a user equipment (UE); transmitting, to the UE, a dual connectivity (DC) configuration; providing a service to the UE with a secondary node (SN) related to a secondary cell group (SCG) in the first network based on the DC configuration; receiving, from the UE via the SCG, conflict information informing a capability conflict between a first resource used in the first network and a second resource for use in a second network, based on the first resource being related to a primary cell (PCell) in the MCG; and transmitting, to the UE via the SCG, one or more mobility commands for a PCell change, wherein the conflict information is received based on the capability conflict being identified by the UE, wherein the capability conflict is identified after an event of establishing a connection between the UE and the second network is detected, and wherein the event of establishing the connection between the UE and the second network is detected while the connection between the UE and the first network is established.

According to an embodiment of the present disclosure, a method performed by a master node (MN) related to a master cell group (MCG) in a first network configured to operate in a wireless communication system comprises: establishing a connection with a user equipment (UE); transmitting, to the UE, a dual connectivity (DC) configuration; providing a service to the UE with a secondary node (SN) related to a secondary cell group (SCG) in the first network based on the DC configuration; receiving, from the UE via the SCG, conflict information informing a capability conflict between a first resource used in the first network and a second resource for use in a second network, based on the first resource being related to a primary cell (PCell) in the MCG; and transmitting, to the UE via the SCG, one or more mobility commands for a PCell change, wherein the conflict information is received based on the capability conflict being identified by the UE, wherein the capability conflict is identified after an event of establishing a connection between the UE and the second network is detected, and wherein the event of establishing the connection between the UE and the second network is detected while the connection between the UE and the first network is established.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict, wherein the conflict information is transmitted via the SCG based on the first resource being related to a primary cell (PCell) in the MCG.

According to an embodiment of the present disclosure, a non-transitory computer readable medium (CRM) has stored thereon a program code implementing instructions that, based on being executed by at least one processor, perform operations comprising: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict, wherein the conflict information is transmitted via the SCG based on the first resource being related to a primary cell (PCell) in the MCG. The present disclosure may have various advantageous effects.

For example, the MUSIM UE may take proper action to resolve the UE capability conflict issue on PCell of the network A. By sending restriction request/conflict information via SRB3 and/or by considering additional condition (i.e., whether SRB3 is available) to initiation of RRC Re-establishment procedure, data transmission delay can decrease.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a dual connectivity (DC) architecture to which technical features of the present disclosure can be applied.

FIG. 9 shows an example of a wireless environment in which a MUSIM device operates according to an embodiment of the present disclosure.

FIG. 10 shows an example of a method performed by a UE according to an embodiment of the present disclosure.

FIG. 11 shows an example of a signal flow between UE and first/second networks according to an embodiment of the present disclosure.

FIG. 12 shows an example of a method for PCell restriction in MUSIM operation according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

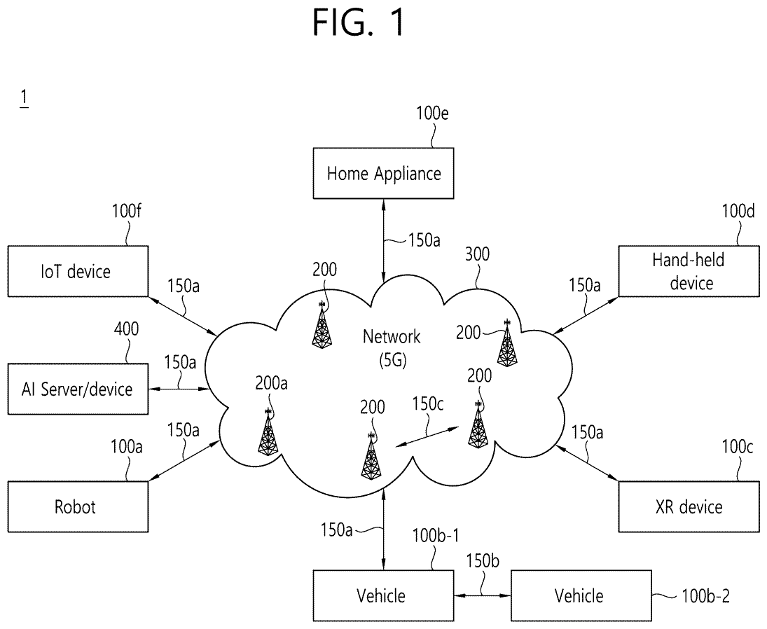

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

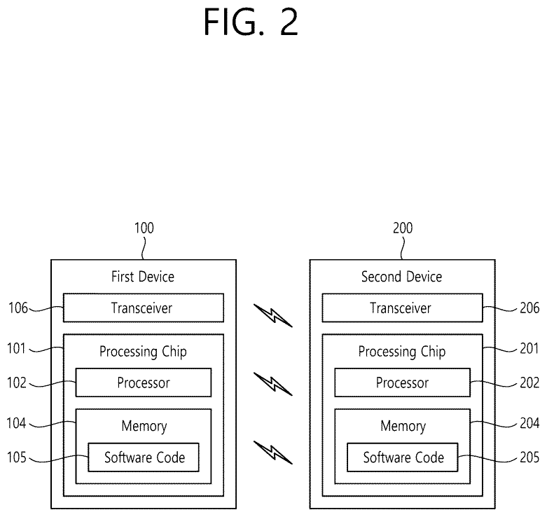

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

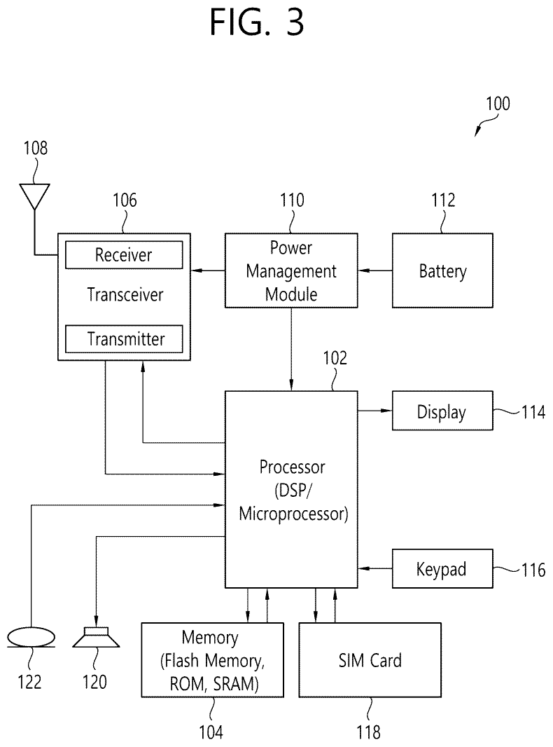

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

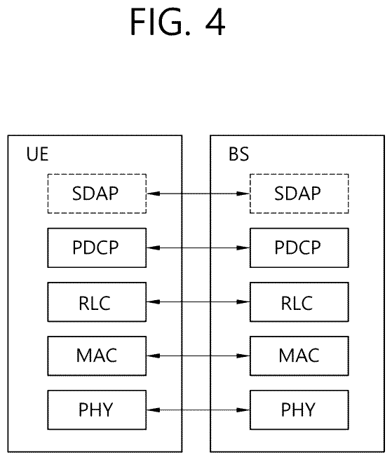

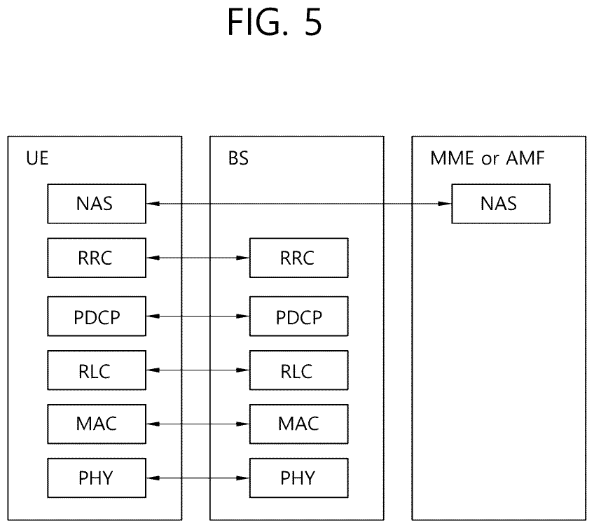

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

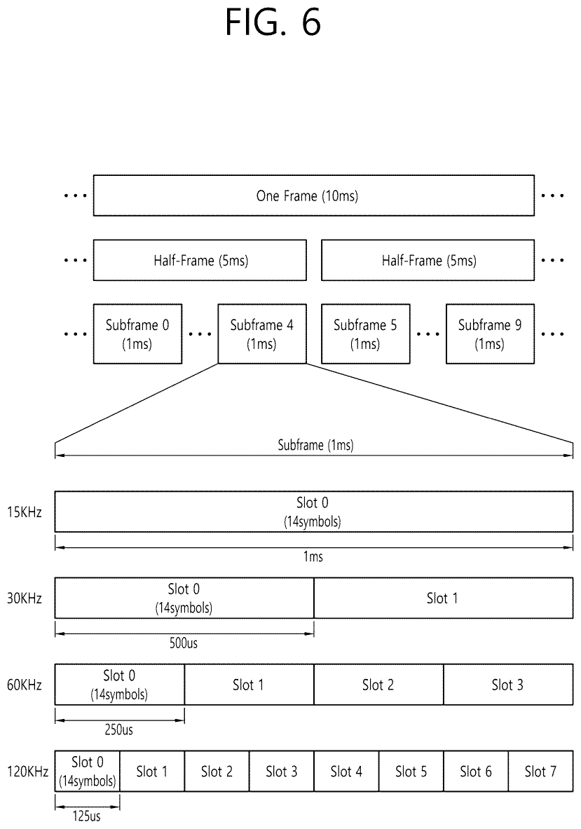

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

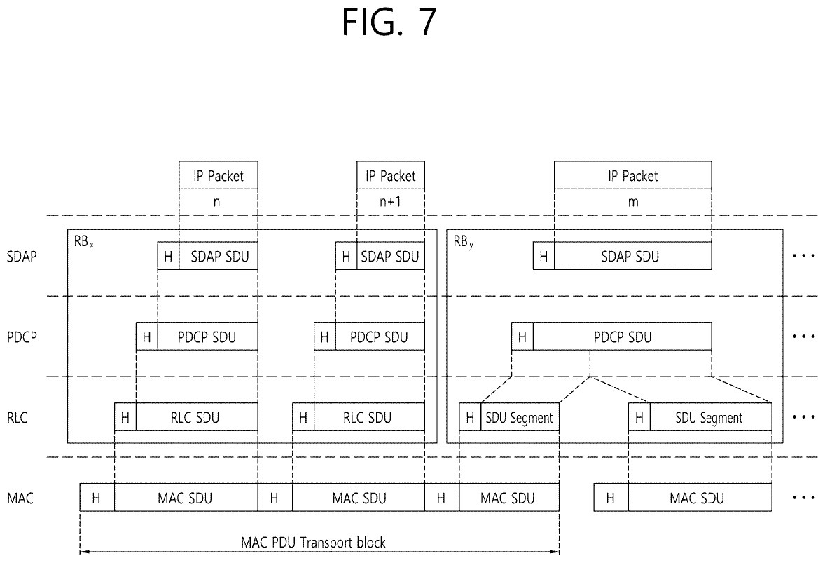

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

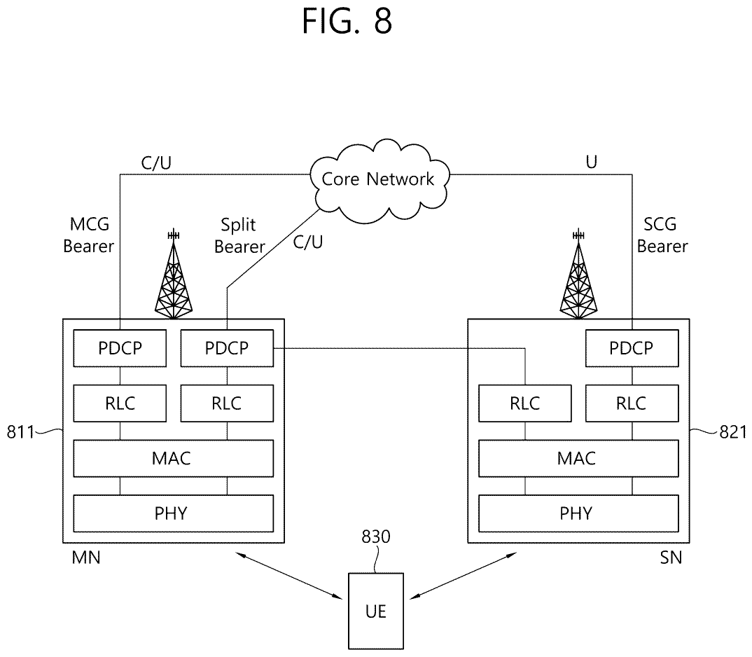

FIG. 8 shows an example of a dual connectivity (DC) architecture to which technical features of the present disclosure can be applied.

Referring to FIG. 8, MN 811, SN 821, and a UE 830 communicating with both the MN 811 and the SN 821 are illustrated. As illustrated in FIG. 8, DC refers to a scheme in which a UE (e.g., UE 830) utilizes radio resources provided by at least two RAN nodes comprising a MN (e.g., MN 811) and one or more SNs (e.g., SN 821). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 811) refers to a main RAN node providing services to a UE in DC situation. SN (e.g., SN 821) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 8, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 8, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 8, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 8, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, “Signalling Radio Bearers” (SRBs) are described.

The SRBs are defined as Radio Bearers (RBs) that are used only for the transmission of RRC and NAS messages. More specifically, the following SRBs are defined:
SRB0 is established between UE and MN/MCG for RRC messages using the CCCH logical channel;
SRB1 is established between UE and MN/MCG for RRC messages (which may include a piggybacked NAS message) as well as for NAS messages prior to the establishment of SRB2, all using DCCH logical channel;
SRB2 is established between UE and MN/MCG for NAS messages and for RRC messages which include logged measurement information, all using DCCH logical channel. SRB2 has a lower priority than SRB1 and may be configured by the network after AS security activation;
SRB3 is established between UE and SN/SCG for specific RRC messages when UE is in (NG) EN-DC or NR-DC, all using DCCH logical channel;
SRB4 is established for RRC messages which include application layer measurement report information, all using DCCH logical channel. SRB4 can only be configured by the network after AS security activation.

In downlink, piggybacking of NAS messages is used only for one dependant (i.e. with joint success/failure) procedure: bearer establishment/modification/release. In uplink piggybacking of NAS message is used only for transferring the initial NAS message during connection setup and connection resume.

The NAS messages transferred via SRB2 are also contained in RRC messages, which however do not include any RRC protocol control information.

Once AS security is activated, all RRC messages on SRB1, SRB2, SRB3 and SRB4, including those containing NAS messages, are integrity protected and ciphered by PDCP. NAS independently applies integrity protection and ciphering to the NAS messages.

Split SRB is supported for all the MR-DC options in both SRB1 and SRB2 (split SRB is not supported for SRB0 and SRB3).

For operation with shared spectrum channel access, SRB0, SRB1 and SRB3 are assigned with the highest priority Channel Access Priority Class (CAPC), (i.e. CAPC=1) while CAPC for SRB2 is configurable.

Hereinafter, contents related to a multi-universal subscriber identity module (MUSIM) is described.

Multi-USIM devices have been more and more popular in different countries. The user may have both a personal and a business subscription in one device or have two personal subscriptions in one device for different services.

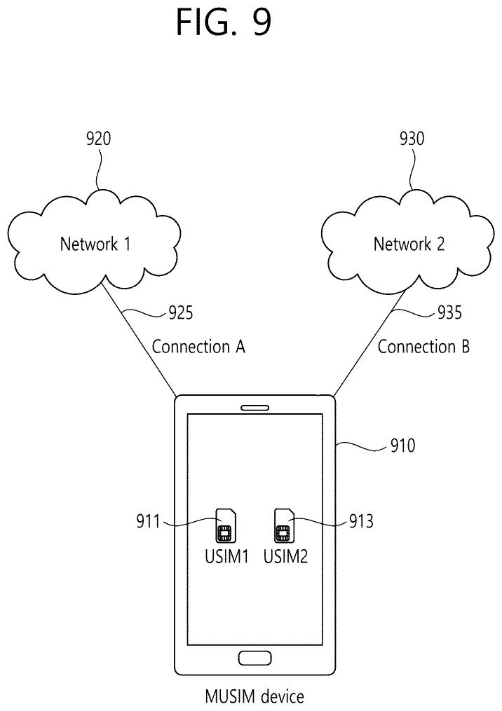

FIG. 9 shows an example of a wireless environment in which a MUSIM device operates according to an embodiment of the present disclosure.

Referring to FIG. 9, MUSIM device 910 (or, MUSIM UE 910) may have a plurality of universal subscriber identity modules (USIMs)-USIM1 911 (or, USIM A 911) and USIM2 913 (USIM B 913). The MUSIM device 910 may register to a network 1 (or, network A) 920 based on subscription information in the USIM1 911 to obtain a connection A 925 between the network 1 920 and the MUSIM device 910. The MSUIM device 910 may also register to a network 2 (or, network B) 930 based on subscription information in the USIM2 913 to obtain a connection B 935 between the network 2 930 and the MUSIM device 910. The MUSIM device 910 may use the USIM1 911 to perform a communication with the network 1 920 over the connection A 925, and use the USIM2 913 to perform a communication with the network 2 930 over the connection B 935.

In a wireless environment in which a MUSIM device operates, the following properties may hold:
Each registration from the USIMS of a MUSIM device may be handled independently.
Each registered USIM in the MUSIM device may be associated with a dedicated international mobile equipment identity (IMEI)/permanent equipment identifier (PEI).
A MUSIM UE may be connected with i) evolved packet system (EPS) on one USIM and 5G system (5GS) on the other USIM; ii) EPS on both USIMs; or iii) 5GS on both USIMs.
A MUSIM UE may be a single reception (RX)/dual RX/single transmission (TX)/Dual TX UE. Single RX may allow the MUSIM UE to receive traffic from only one network at one time. Dual RX may allow the MUSIM UE to simultaneously receive traffic from two networks. Single TX may allow the MUSIM UE to transmit traffic to one network at one time. Dual TX may allow the MUSIM UE to simultaneously transmit traffic to two networks. The terms single RX/TX and Dual RX/TX do not refer to a device type. A single UE may, as an example, use Dual TX in some cases but Single TX in other case.
If/when the multiple USIMs in the MUSIM device are served by different serving networks, network coordination between the serving networks may not be required.
A MUSIM device with different USIMs may be camping with all USIMs on the same serving network RAN node, or the MUSIM device may be camping on different serving networks RAN nodes.
USIMs may belong to same or different operators. Coordination between involved operators may not be required.
USIM may be a physical SIM or embedded SIM (eSIM).

While actively communicating with a first system/network, a MUSIM UE may need to periodically monitor a second system/network (e.g. to synchronize, read the paging channel, perform measurements, or read the system information). The periodical activity on the second system may or may not have performance impact on the first system the UE is communicating with, depending on the UE implementation (i.e., single reception (Rx) or dual Rx).

In some cases, the UE equipped with different USIMs may have paging collisions which results in missed paging. When the UE receives a page in the second system while actively communicating with the first system, the UE may need to decide whether the UE should respond to this paging or not. When the UE decides to respond to the paging in the second system, the UE may need to stop the current activity in the first system. For example, the first system may suspend or release the ongoing connection with the UE.

For MUSIM operation, a MUSIM device in RRC_CONNECTED state in Network A may have to switch from Network A to Network B. For example, the MUSIM device in RRC_CONNECTED state in Network A may perform a network switching from Network A to Network B (or, perform SIM switching from a SIM associated with Network A to a SIM associated with Network B) and establish a connection with Network B (and enter RRC_CONNECTED in Network B), based on receiving a paging from Network B. Herein, Network A may be NR and Network B can either be E-UTRA or NR. Before switching from Network A, a MUSIM device should notify Network A to either leave RRC_CONNECTED state, or be kept in RRC_CONNECTED state in Network A while temporarily switching to Network B.

For example, when configured to do so, a MUSIM device can signal to the Network A a preference to leave RRC_CONNECTED state by using RRC or NAS signalling. After sending a preference to leave RRC_CONNECTED state by using RRC signalling, if the MUSIM device does not receive an RRCRelease message from the Network A within a certain time period (configured by the Network A), the MUSIM device can enter RRC_IDLE state in Network A.

For example, when configured to do so, a MUSIM device can signal to the Network A a preference to be temporarily switching to Network B while remaining in RRC_CONNECTED state in Network. This is indicated by scheduling gaps preference. This preference can include information for setup or release of gap(s). The Network A can configure at most 4 gap patterns for MUSIM purpose: three periodic gaps and a single aperiodic gap. The Network A should always provide at least one of the requested gap pattern or no gaps. Network may provide an alternative gap pattern instead of the one requested by the UE.

In the present disclosure, if UE's capability does not support simultaneously performing operations on a first resource and operations on a second resource, it may be referred to as there is a capability conflict between the first resource and the second resource, and/or the first resource conflicts the second resource. The capability conflict may occur in MUSIM operation, for example, between the first resource in network A associated with USIM A and the second resource in network B associated with USIM B.

Solutions for the capability conflict in MUSIM operation shall not require network coordination for the case where multiple USIMs in the Multi-USIM device are served by different serving networks. That is, the capability conflict in MUSIM operation may be a conflict that is unable to be solved by network coordination between network A and network B, and/or a conflict that is based on network A and network B being unable to coordinate resources to resolve the conflict, and/or a conflict between the first resource and the second resources that are unable to be coordinated by network A and network B.

Meanwhile, the Multi-USIM (MUSIM) function aims to support a scenario where the UE in both SIM A (i.e., network A) and SIM B (i.e., network B) establishes each RRC connection and transmits/receives data at the same time.

In this scenario, the UE may suffer a temporary hardware conflict between the serving cell of the network B and the CA/DC configuration of the network A due to RRC connection establishment of the network B. This is because the frequency of the serving cell on the network B can cause a conflict to some serving frequencies for CA/DC on the network A. If the temporary hardware conflict occurs, the UE may not be able to use some resources of the problematic CA/DC configuration of the network A until the RRC connection release of the network B.

For example, the problem may occur when a cell in the network A suffering the temporary hardware conflict is a PCell. Since there is no inter coordination signalling between the network A and the network B, the frequency of the network B not only affects the CA/DC operation in the network A but also the PCell in the network A. Therefore, it is necessary for the UE to perform proper UE actions when the PCell in the network A suffers the temporary hardware conflict with the serving cell of the network B due to Multi-USIM operation.

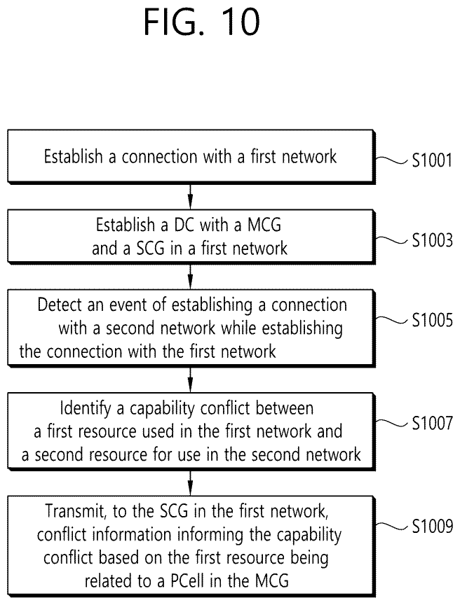

FIG. 10 shows an example of a method performed by a UE according to an embodiment of the present disclosure. The method may also be performed by a wireless device.

Referring to FIG. 10, in step S1001, the UE may establish a connection with a first network.

In step S1003, the UE may establish a DC with a MCG and a SCG in the first network.

In step S1005, the UE may detect an event of establishing a connection with a second network while establishing the connection with the first network.

In step S1007, after detecting the event of establishing the connection with the second network, the UE may identify a capability conflict between a first resource used in the first network and a second resource for use in the second network.

In step S1009, the UE may transmit, to the SCG in the first network, conflict information informing the capability conflict based on the first resource being related to a PCell in the MCG. The UE may transmit the conflict information informing the capability conflict to the first network based on identifying the capability conflict, and the conflict information may be transmitted via the SCG based on the first resource being related to the PCell in the MCG.

According to various embodiments, the UE may be a multiple universal subscriber identity module (MUSIM) UE equipped with USIMs comprising a first SIM associated with the first network and a second SIM associated with the second network. The UE may register to the first network based on subscription information stored in the first SIM. The UE may register to the second network based on subscription information stored in the second SIM.

According to various embodiments, the capability conflict may be identified based on at least one of: a capability of the UE being unable to support simultaneously performing operations on the first resource and the second resource; or the first network and the second network being unable to coordinate the first resource and the second resource to resolve the capability conflict. The first resource may conflict the second resource based on at least one of: the first resource being adjacent to the second resource; or the first resource at least partially overlapping or fully overlapping the second resource.

According to various embodiments, the first resource may comprise a frequency of the PCell in the first network. The second resource may comprise a frequency of a camping cell on the second network that is to be a serving cell on the second network.

According to various embodiments, the event of establishing the connection with the second network may be detected based on at least one of: the UE receiving a paging from the second network; or a paging cause in the paging to initiate a voice call on the second network.

According to various embodiments, the conflict information may comprise at least one of: a conflict indication indicating that the capability conflict has occurred; information for a frequency of the PCell; or information for the PCell.

According to various embodiments, the UE may transmit, to the SCG via an SRB3, UE assistance information message comprising the conflict information.

According to various embodiments, the UE may suspend a communication with the first network via the PCell based on identifying the capability conflict. The UE may start a timer upon transmitting the conflict information. The UE may monitor, from the SCG, an RRC reconfiguration to resolve the capability conflict while the timer is running. The RRC reconfiguration may comprise one or more mobility commands for a PCell change.

According to various embodiments, based on the RRC reconfiguration being received by the UE while the timer is running, the UE may stopp the timer; and perform the PCell change to a target PCell in the first network based on applying a target cell configuration in a mobility command related to the target PCell.

According to various embodiments, based on the RRC reconfiguration being not received by the UE while the timer is running and an expiry of the timer, the UE may: initiate an RRC re-establishment procedure; perform a cell selection to select a new PCell in the first network; and perform the RRC re-establishment procedure with the new PCell.

According to various embodiments, the UE may transmit, to the new PCell, an RRC re-establishment request message during the RRC re-establishment procedure. The RRC re-establishment request message may comprise at least one of: a re-establishment cause set as the capability conflict; or the conflict information.

According to various embodiments, based on the capability conflict being resolved while the timer is running, the UE may: stop the timer; and resume the communication with the first network via the PCell. The capability conflict may be resolved based on at least one of: a condition that the connection with the second network has been released; or a condition that a serving frequency of the second network related to the second resource has been changed.

According to various embodiments, the UE may register to a first network and a second network. The UE may utilize a first radio resource for communication with the first network in RRC_CONNECTED. The first radio resource can be utilized with secondary cell group configuration in the first network. The UE may determine to utilize a second resource for communication with the second network. The UE may identify capability conflict between the first radio resource and the second resource based on the utilization status of the second resource (i.e., based on a determination to utilize the second resource). The UE may send, to the first network via the secondary cell group, a first request/conflict information informing that the capability conflict has been detected related to the first radio resource if the capability conflict is identified on PCell in the first network.

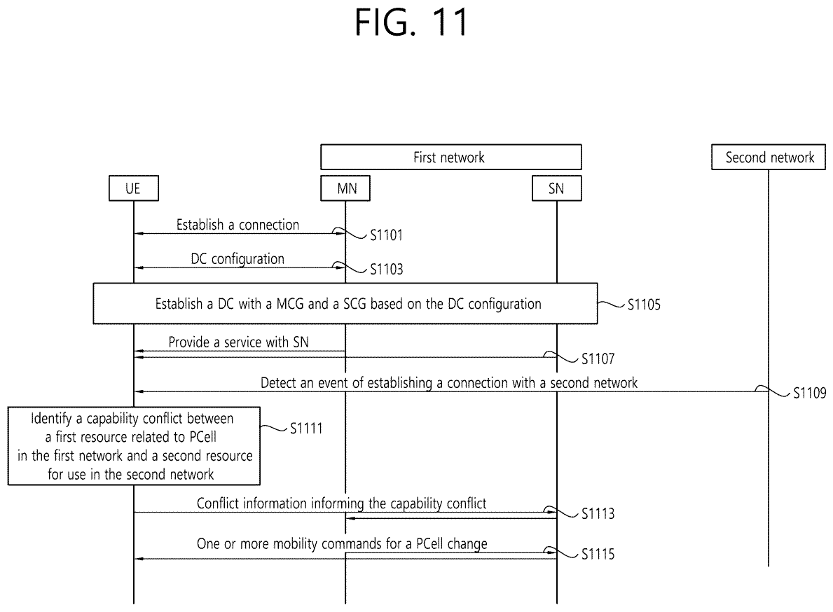

FIG. 11 shows an example of a signal flow between UE and first/second networks according to an embodiment of the present disclosure.

Referring to FIG. 11, in step S1101, the MN in the first network may establish a connection with the UE.

In step S1103, the MN may transmit, to the UE, a DC configuration.

In step S1105, the UE may establish a DC with a MCG/MN and a SCG/SN based on the DC configuration. The MCG may comprise a PCell and optionally one or more SCells. The SCG may comprise a PSCell and optionally one or more SCells.

In step S1107, the MN may provide a provide a service to the UE with the SN in the first network based on the DC configuration.

In step S1109, the UE may detect an event of establishing a connection with the second network while establishing the connection between the UE and the first network.

In step S1111, after detecting the event of establishing the connection with the second network, the UE may identify a capability conflict between a first resource related to the PCell in the first network and a second resource for use in the second network.

In step S1113, the UE may transmit, to the MN via the SCG, conflict information informing the capability conflict based on identifying the capability conflict. That is, the MN may receive, from the UE via the SCG, the conflict information informing the capability conflict.

In step S1115, the MN may transmit, to the UE via the SCG, one or more mobility commands for a PCell change. The UE may perform the PCell change to a target PCell in the first network based on applying a target cell configuration in a mobility command related to the target PCell.

According to implementations of the present disclosure, while performing Multi-USIM operation, when the UE confirms in advance that RRC connection needs to be established/resumed in the network B if the UE determines that the frequency of the camping cell or serving cell on the network B will cause or has already caused a conflict with serving frequency of PCell on the network A, the UE may check whether SRB (i.e., SRB3) is available/established to send an RRC signalling to a secondary cell group to request a resolution for the conflict. If the SRB is available to send the RRC signalling to the secondary cell group, the UE may send an RRC signalling (e.g., MUSIM assistance information in UE Assistance Information message) comprising conflict information to the secondary cell group to indicate that the UE has the conflict on PCell due to Multi-USIM operation. Otherwise (i.e., the SRB is not available to send the RRC signalling to the secondary cell group), the UE may initiate RRC Re-establishment procedure to select other cell for new PCell.

Due to the conflict, the UE may suffer a problem that some conflicted resources cannot be used according to the network configuration. The conflict resources may comprise radio resources of one or more serving cells configured for the corresponding network. For example, in the network A, the conflicted resources may comprise radios resources for serving cells for CA/DC operation if configured. For example, in the network B, the conflicted resources may comprise radio resources for serving cell/camping cell if configured. For example, in the network A, the conflicted resources may also comprise radio resources for PCell.

To check whether the conflict occurs due to Multi-USIM operation, the UE may determine (in advance) if any resources configured by the network A may lead to the problem such as incomplete configuration and/or capability conflict with the resources in the network B before the UE successfully completes the RRC connection establishment/resumption in the network B.

For example, the UE may confirm in advance that RRC connection needs to be established/resumed in the network B, based on at least one of the conditions below:
when the UE has received a paging message from the network B; and/or
when the UE checks whether to initiate a voice call service on the network B via a paging cause in the paging message.

Thus, through these conditions, the UE may check whether any service/serving frequency of the network A will suffer a conflict to use the resources together with the current camping cell's frequency on the network B when the UE has received a paging message from the network B or when the UE checks whether to initiate a voice call service on the network B via a paging cause in the paging message.

When sending RRC signalling to the network, the UE may include the conflict information in RRC signalling like below:
frequency information to indicate which frequency causes the conflict on the network B;
cell information to indicate which cell cause the conflict on the network B;
frequency information of PCell on the network A; and/or
cell information of PCell on the network A.

In case of that the UE uses SRB to send an RRC signalling comprising the conflict information to the secondary cell group to indicate that the UE has the conflict on PCell due to Multi-USIM operation, the UE may have the same signalling procedure as the MCG failure information procedure. That is, if SRB1 is configured as split SRB, the UE may transmit the RRC signalling comprising the conflict information via SRB1. Else if SRB3 is configured, the UE may transmit the RRC signalling (e.g., RRC message ULInformationTransferMRDC) comprising the conflict information via SRB3.

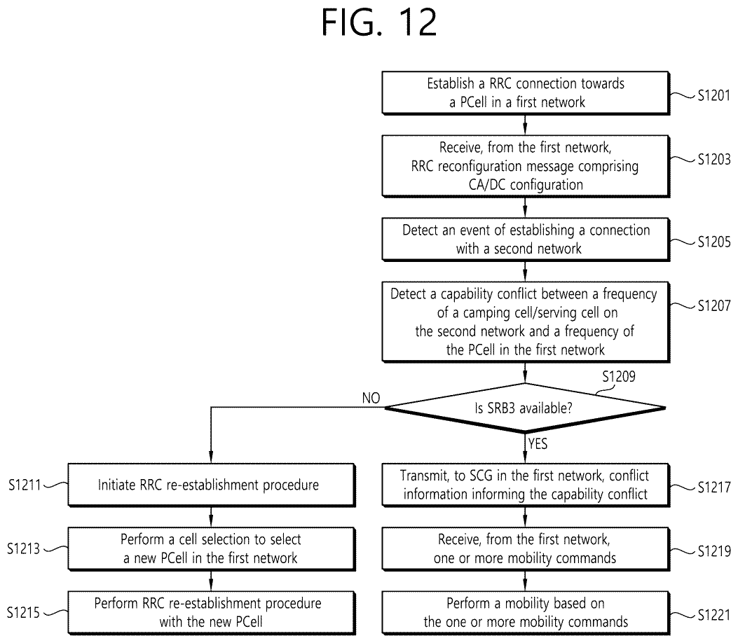

FIG. 12 shows an example of a method for PCell restriction in MUSIM operation according to an embodiment of the present disclosure. The method may be performed by a UE and/or wireless device.

Referring to FIG. 12, in step S1201, the UE may establish an RRC connection towards a PCell/first cell in a first network, and enter in RRC_CONNECTED state. The PCell may be included in MCG associated with MN. The first network may allow sending a request of temporary UE capability restriction due to Multi-USIM operation. In the second network, the UE may camp on a second cell.

In step S1203, the UE may receive, from the first network, RRC reconfiguration message comprising CA/DC configuration. The UE may have been configured with the CA/DC configuration via the RRC reconfiguration message. The UE may activate one or more serving cells for CA/DC according to the received CA/DC configuration. For example, the UE may activate PSCell/SCG associated with SN based on the DC configuration (e.g., SCG configuration). For example, the UE may activate one or more SCells in the MCG/SCG based on the CA configuration.

In step S1205, the UE may detect an event of establishing a connection with the second network. For example, the UE may receive a paging message from the second cell in the second network to establish an RRC connection. In the paging message, paging cause information may be included to indicate a voice call service in the second network. The UE may still be in RRC_IDLE or RRC_INACTIVE state in the second network.

In step S1207, the UE may detect a capability conflict between a frequency of a camping cell/serving cell on the second network and a frequency of the PCell in the first network. Upon reception of the paging message from the second network, the UE may check if at least one frequency related to all serving cells for CA/DC in the first network will have any conflict when the UE enters RRC_CONECTED state on the second cell of the second network. That is, the UE may check if the frequency of the second cell on the second network will cause a conflict with at least one serving cell's frequency of the first network.

The UE may determine that there is at least one serving cell in the first network whose frequency can lead to the problem such as incomplete configuration and/or capability conflict due to RRC connection with the second network, and the at least one serving cell comprises PCell.

After/based on detecting the capability conflict, in step S1209, the UE may check whether SRB3 is available. The UE may suspend a communication with the first network via the PCell.

If the SRB3 is not available, in step S1211, the UE may initiate an RRC re-establishment procedure in the first network.

In step S1213, the UE may perform a cell selection to select a new PCell in the first network.

In step S1215, the UE may perform the RRC re-establishment procedure with the new PCell. During the RRC re-establishment procedure, the UE may send an RRC message, e.g., RRCRe-establishmentRequest message to the first network. In the RRC message, the UE may set the re-establishment cause as Multi-USIM conflict and may include the conflict information (e.g., frequency information and/or cell information causing the conflict on the second network). If the UE sent the RRC re-establishment request message, the first network may provide an RRC signaling for the resolution of the conflict. For example, the first network may provide an RRC re-establishment message with a resolution of the conflict.

If the SRB3 is available, in step S1217, the UE may transmit, to the SCG in the first network, conflict information informing the capability conflict. For example, the UE may send an RRC message, e.g. UEAssistanceInformation message comprising the conflict information to indicate that the PCell has a problem due to conflict with Multi-USIM operation. In the RRC message and/or the conflict information, the UE may include frequency information and/or cell information causing the conflict on the second network. Upon transmitting the RRC message/conflict information, the UE may start a timer.

In step S1219, upon the UE sending the RRC message/conflict information, the first network may provide an RRC signaling for the resolution of the conflict. For example, the first network may provide RRC reconfiguration message with a handover command, i.e., reconfiguration with sync as a resolution of the conflict. The UE may receive, from the first network, the RRC reconfiguration message comprising one or more mobility commands for a PCell change, while the timer is running.

In step S1221, the UE may stop the timer, and perform a mobility based on the one or more mobility commands. For example, the UE may perform the PCell change to a target PCell based on applying a target cell configuration in a mobility command related to the target PCell.

In some implementations, the UE may not receive the RRC reconfiguration message comprising one or more mobility commands for a PCell change from the first network while the timer is running and the timer may expire. In this case, the UE may initiate an RRC re-establishment procedure in the first network and/or perform steps S1211 to S1215.

In some implementations, the capability conflict may be resolved (e.g., connection with the second network has been released and/or a serving frequency of the second network has been changed) while the timer is running. In this case, the UE may stop the timer, and resume the communication with the first network via the PCell.

Furthermore, the method in perspective of the UE described in the present disclosure (e.g., in FIG. 10) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict. The conflict information may be transmitted via the SCG based on the first resource being related to a primary cell (PCell) in the MCG.

Furthermore, the method in perspective of the UE described in the present disclosure (e.g., in FIG. 10) may be performed by a software code 105 stored in the memory 104 included in the first wireless device 100 shown in FIG. 2.

More specifically, at least one computer readable medium (CRM) stores instructions that, based on being executed by at least one processor, perform operations comprising: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict. The conflict information may be transmitted via the SCG based on the first resource being related to a primary cell (PCell) in the MCG.

Furthermore, the method in perspective of the UE described in the present disclosure (e.g., in FIG. 10) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: establishing a connection with a first network; establishing a dual connectivity (DC) with a master cell group (MCG) and a secondary cell group (SCG) in the first network; detecting an event of establishing a connection with a second network while establishing the connection with the first network; after detecting the event of establishing the connection with the second network, identifying a capability conflict between a first resource used in the first network and a second resource for use in the second network; and based on identifying the capability conflict, transmitting, to the first network, conflict information informing the capability conflict. The conflict information may be transmitted via the SCG based on the first resource being related to a primary cell (PCell) in the MCG.

Furthermore, the method in perspective of MN related to MCG in a first network described in the present disclosure (e.g., in FIG. 11) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: establishing a connection with a user equipment (UE); transmitting, to the UE, a dual connectivity (DC) configuration; providing a service to the UE with a secondary node (SN) related to a secondary cell group (SCG) in the first network based on the DC configuration; receiving, from the UE via the SCG, conflict information informing a capability conflict between a first resource used in the first network and a second resource for use in a second network, based on the first resource being related to a primary cell (PCell) in the MCG; and transmitting, to the UE via the SCG, one or more mobility commands for a PCell change. The conflict information may be received based on the capability conflict being identified by the UE. The capability conflict may be identified after an event of establishing a connection between the UE and the second network is detected. The event of establishing the connection between the UE and the second network may be detected while the connection between the UE and the first network is established.

The present disclosure may have various advantageous effects.

For example, the MUSIM UE may take proper action to resolve the UE capability conflict issue on PCell of the network A. By sending restriction request/conflict information via SRB3 and/or by considering additional condition (i.e., whether SRB3 is available) to initiation of RRC Re-establishment procedure, data transmission delay can decrease.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
establishing a connection with a first network;
establishing a dual connectivity (DC) with a master cell group (MCG) and a secondary cell group (SCG) in the first network;
detecting an event of establishing a connection with a second network while establishing the connection with the first network;
after detecting the event of establishing the connection with the second network, identifying a capability conflict between a first resource used in the first network and a second resource for use in the second network; and
based on identifying the capability conflict, transmitting, to the first network, conflict information informing the capability conflict,
wherein the conflict information is transmitted via the SCG based on the first resource being related to a primary cell (PCell) in the MCG.

2. The method of claim 1, wherein the method is performed by a user equipment (UE) which is a multiple universal subscriber identity module (MUSIM) UE equipped with USIMs comprising a first SIM associated with the first network and a second SIM associated with the second network, and
wherein the method further comprises:
registering to the first network based on subscription information stored in the first SIM; and
registering to the second network based on subscription information stored in the second SIM.

3. The method of claim 1, wherein the capability conflict is based on at least one of:
a capability of a user equipment (UE) being unable to support simultaneously performing operations on the first resource and the second resource; or
the first network and the second network being unable to coordinate the first resource and the second resource to resolve the capability conflict; and
wherein the first resource conflicts the second resource based on at least one of:
the first resource being adjacent to the second resource; or
the first resource at least partially overlapping or fully overlapping the second resource.

4. The method of claim 1, wherein the first resource comprises a frequency of the PCell in the first network, and
wherein the second resource comprises a frequency of a camping cell on the second network that is to be a serving cell on the second network.

5. The method of claim 1, wherein the event of establishing the connection with the second network is detected based on at least one of:
the UE receiving a paging from the second network; or
a paging cause in the paging to initiate a voice call on the second network.

6. The method of claim 1, wherein the conflict information comprises at least one of:
a conflict indication indicating that the capability conflict has occurred;
information for a frequency of the PCell; or
information for the PCell.

7. The method of claim 1, wherein the transmitting of the conflict information comprises transmitting, to the SCG via a signalling radio bearer 3 (SRB3), UE assistance information message comprising the conflict information.

8. The method of claim 1, further comprising:
suspending a communication with the first network via the PCell based on identifying the capability conflict;
starting a timer upon transmitting the conflict information; and
monitoring, from the SCG, a radio resource control (RRC) reconfiguration to resolve the capability conflict while the timer is running,
wherein the RRC reconfiguration comprises one or more mobility commands for a PCell change.

9. The method of claim 8, based on the RRC reconfiguration being received by the UE while the timer is running, further comprising:
stopping the timer; and
performing the PCell change to a target PCell in the first network based on applying a target cell configuration in a mobility command related to the target PCell.

10. The method of claim 8, based on the RRC reconfiguration being not received by the UE while the timer is running and an expiry of the timer, further comprising:
initiating an RRC re-establishment procedure;
performing a cell selection to select a new PCell in the first network; and
performing the RRC re-establishment procedure with the new PCell.

11. The method of claim 10, wherein the performing of the RRC re-establishment procedure comprises transmitting, to the new PCell, an RRC re-establishment request message during the RRC re-establishment procedure, and
wherein the RRC re-establishment request message comprises at least one of:
a re-establishment cause set as the capability conflict; or
the conflict information.

12. The method of claim 8, based on the capability conflict being resolved while the timer is running, further comprising:
stopping the timer; and
resuming the communication with the first network via the PCell,
wherein the capability conflict is resolved based on at least one of:
a condition that the connection with the second network has been released; or
a condition that a serving frequency of the second network related to the second resource has been changed.

13. The method of claim 1, wherein the method is performed by a user equipment (UE) in communication with at least one of a mobile device, a network, or autonomous vehicles.

14. A user equipment (UE) configured to operate in a-wireless communication system, the UE comprising:
at least one transceiver;
at least one processor; and
at least one memory operatively coupled to the at least one processor and storing instructions that, based on being executed by the at least one processor, perform operations comprising:
establishing a connection with a first network;
establishing a dual connectivity (DC) with a master cell group (MCG) and a secondary cell group (SCG) in the first network;
detecting an event of establishing a connection with a second network while establishing the connection with the first network;
after detecting the event of establishing the connection with the second network, identifying a capability conflict between a first resource used in the first network and a second resource for use in the second network; and
based on identifying the capability conflict, transmitting, to the first network, conflict information informing the capability conflict,
wherein the conflict information is transmitted via the SCG based on the first resource being related to a primary cell (PCell) in the MCG.

15. (canceled)

16. A master node (MN) related to a master cell group (MCG) in a first network, comprising:
at least one transceiver;
at least one processor; and
at least one memory operatively coupled to the at least one processor and storing instructions that, based on being executed by the at least one processor, perform operations comprising:
establishing a connection with a user equipment (UE);
transmitting, to the UE, a dual connectivity (DC) configuration;
providing a service to the UE with a secondary node (SN) related to a secondary cell group (SCG) in the first network based on the DC configuration;
receiving, from the UE via the SCG, conflict information informing a capability conflict between a first resource used in the first network and a second resource for use in a second network, based on the first resource being related to a primary cell (PCell) in the MCG; and
transmitting, to the UE via the SCG, one or more mobility commands for a PCell change,
wherein the conflict information is received based on the capability conflict being identified by the UE,
wherein the capability conflict is identified after an event of establishing a connection between the UE and the second network is detected, and
wherein the event of establishing the connection between the UE and the second network is detected while the connection between the UE and the first network is established.

17-20. (canceled)
